(19) United States
(12) Patent Application Publication
(10) Pub. No.: US 2018/0366860 A1
(43) Pub. Date: Dec. 20, 2018

(54) FEMALE TERMINAL, CONNECTOR, AND METHOD FOR PRODUCING CONNECTOR

(71) Applicant: DAI-ICHI SEIKO CO., LTD., Kyoto-shi (JP)

(72) Inventor: Hikaru Naoi, Shizuoka-shi (JP)

(21) Appl. No.: 15/992,659

(22) Filed: May 30, 2018

(30) Foreign Application Priority Data
Jun. 15, 2017 (JP) 2017-117835

(51) Int. Cl. H01R 13/432; H01R 13/10

(52) U.S. Cl. CPC H01R 13/432; H01R 13/10

(57) ABSTRACT

A female terminal is inserted into a tubular terminal housing space formed in either of two types of connector housings. The female terminal includes: a hollow tubular body into which a male terminal that is a mating terminal, is to be inserted; a lock portion that is disposed on a top plate of the body and that is to be locked by a lance formed in a connector housing of one type; and a lock portion that is disposed on an outer bottom plate facing the top plate of the body and that is to be locked by a lance formed in a connector housing of the other type.

### CROSS-REFERENCE TO RELATED APPLICATION

This application claims the benefit of Japanese Patent Application No. 2017-117835, filed on Jun. 15, 2017, the entire disclosure of which is incorporated by reference herein.

### FIELD OF THE INVENTION

The present disclosure relates to a female terminal, a connector, and a method for producing a connector.

### BACKGROUND OF THE INVENTION

A connector on the female side comprises a connector housing and a female terminal housed therein. A locking mechanism is provided on both of the female terminal and the connector housing to prevent the female terminal from being released from the connector housing. Unexamined Japanese Patent Application Kokai Publication No. 2013-137949 states that a lock portion is disposed on one side of a female terminal body formed in a rectangular tube so as to be locked by a lance (a locking mechanism for retaining the female terminal) disposed inside the terminal housing space in the connector housing.

According to Unexamined Japanese Patent Application Kokai Publication No. 2013-137949, a lock portion is disposed on one side of the body of a female terminal. Accordingly, the housing can only be used when the lance is formed to be adapted to the lock portion. In other words, an existing unmodified female terminal cannot be used in any connector housing that has the lance formed at a different position, that is, a different type of connector housing.

The present disclosure has been created in view of the foregoing circumstances, and an objective of the disclosure is to provide a female terminal, a connector, and a method for producing a connector, where the female terminal can be used for different types of connector housings.

### SUMMARY OF THE INVENTION

To achieve the above-described objective, a female terminal according to a first aspect of the present disclosure is:

a female terminal to be inserted into a tubular terminal housing space formed within either of two types of insulative connector housings, the female terminal including:

a hollow tubular body into which a male terminal that is a mating terminal, is to be inserted;

a first lock portion that is disposed on a first face of the body and that is to be locked by a lance formed in a connector housing of one type; and

a second lock portion that is disposed on a second face facing the first face of the body and that is to be locked by a lance formed in a connector housing of another type.

The first lock portion may include a projection in such a form that a cut portion made in the first face of the body is bent inward from the body.

The second lock portion may include a projection in such a form that part of the second face of the body protrudes outward from the body.

To achieve the aforementioned objective, a connector according to a second aspect of the present disclosure is:

a connector including a first connector housing, a second connector housing, and a plurality of female terminals allowed to be fitted into any of the first connector housing and the second connector housing,

wherein the first connector housing includes: a first terminal housing space that is capable of housing each of the female terminals; and a first lance that locks each of the female terminals,

wherein the second connector housing includes: a second terminal housing space that is capable of housing each of the female terminals; and a second lance that locks each of the female terminals and that is in a shape different from the first lance,

wherein the female terminals each include:
a hollow tubular body into which a male terminal is to be inserted;
a first lock portion disposed on a first face of the body; and
a second lock portion disposed on a second face facing the first face of the body,

wherein at least one of the female terminals is fitted into the first terminal housing space in the first connector housing with the first lock portion locked by the first lance, and

wherein other remaining female terminals are each fitted into the second terminal housing space in the second connector housing with the second lock portion locked by the second lance.

The first terminal housing space in the first connector housing may include a space in such a size and shape that the second lock portion of the female terminal does not prevent the female terminal from entering the first terminal housing space, and

the second terminal housing space in the second connector housing may include a space in such a size and shape that the first lock portion of the female terminal does not prevent the female terminal from entering the second terminal housing space.

The female terminal may include an abutment on the second face, the abutment being to abut on an inner surface of the second terminal housing space.

To achieve the aforementioned objective, a method for producing a connector according to a third aspect of the present disclosure includes:

preparing
a first connector housing that is capable of housing each of a plurality of female terminals and that includes a first terminal housing space in which a first lance is formed,
a second connector housing that is capable of housing each of the plurality of female terminals and that includes a second terminal housing space in which a second lance is formed, and
the plurality of female terminals each of which has an identical structure and includes: a hollow tubular body into which a male terminal is to be inserted; a first lock portion that is disposed on a first face of the body and that is to be locked by the first lance; and a second lock portion that is disposed on a second face facing the first face of the body and that is to be locked by the second lance;

fitting at least one of the female terminals into the first terminal housing space in the first connector housing so that the first lock portion is locked by the first lance; and

fitting each of other remaining female terminals into the second terminal housing space in the second connector housing so that the second lock portion is locked by the second lance.

The female terminal according to the present disclosure includes a first lock portion and a second lock portion. Hence, the female terminal can be applied to both of the connector housings that are adapted to the first lock portion and the second lock portion, respectively. Therefore, the female terminal can be used for the different types of connector housings.

### BRIEF DESCRIPTION OF THE DRAWINGS

A more complete understanding of this application can be obtained when the following detailed description is considered in conjunction with the following drawings, in which:

FIG. 1A is a perspective view of a female terminal seen from an obliquely upper position;

FIG. 1B is a perspective view of the female terminal seen from another obliquely upper position;

FIG. 2A is a perspective view of the female terminal seen from an obliquely lower position;

FIG. 2B is a perspective view of the female terminal seen from another obliquely lower position;

FIG. 3A is a plan view of the female terminal seen in a direction indicated by the arrow III A in FIG. 1A;

FIG. 3B is a bottom view of the female terminal seen in a direction indicated by the arrow III B in FIG. 1A;

FIG. 3C is a front view of the female terminal seen in a direction indicated by the arrow III C in FIG. 1A;

FIG. 4A is a side view of the female terminal seen in a direction indicated by the arrow IV A in FIG. 1A;

FIG. 4B is a side view of the female terminal seen in a direction indicated by the arrow IV B in FIG. 1A;

FIG. 5 is a cross-sectional view of the female terminal taken along the line A-A in FIG. 3C;

FIG. 6A is a front view of a connector seen from the entry for a male terminal with a secondary lock portion unlocked;

FIG. 6B is a cross-sectional view of the connector taken along the line A-A in FIG. 6A with the secondary lock portion unlocked;

FIG. 7 is a cross-sectional view of the connector taken along the line A-A in FIG. 6A;

FIG. 8A is a front view of a connector seen from the entry for a male terminal with a secondary lock portion unlocked;

FIG. 8B is a cross-sectional view of the connector taken along the line B-B in FIG. 8A with the secondary lock portion unlocked; and

FIG. 9 is a cross-sectional view of the connector taken along the line B-B in FIG. 8A.

### DETAILED DESCRIPTION OF INVENTION

An embodiment of the present disclosure will now be described with reference to the drawings. XYZ coordinates are applied to the drawings and referred to as appropriate. A female terminal 100 according to the present embodiment can be used in any of two different connector housings having different shapes.

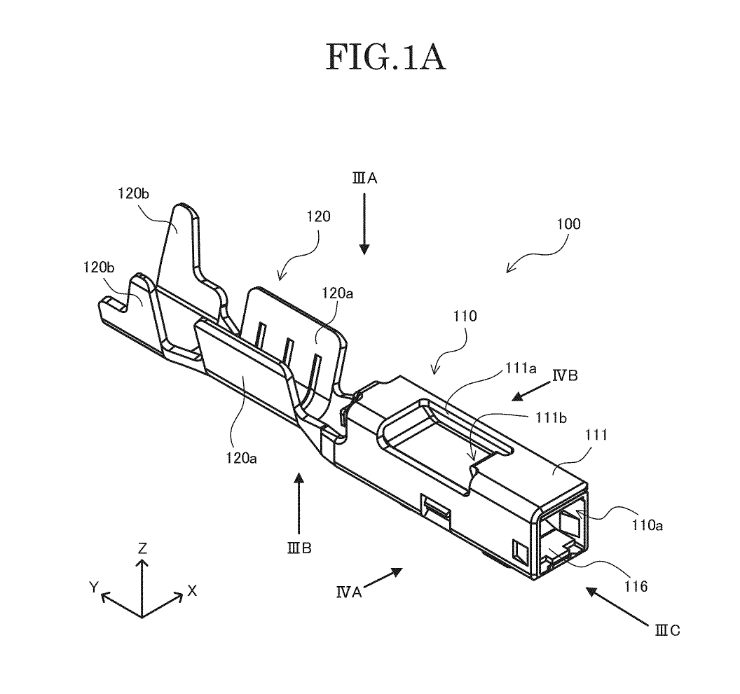

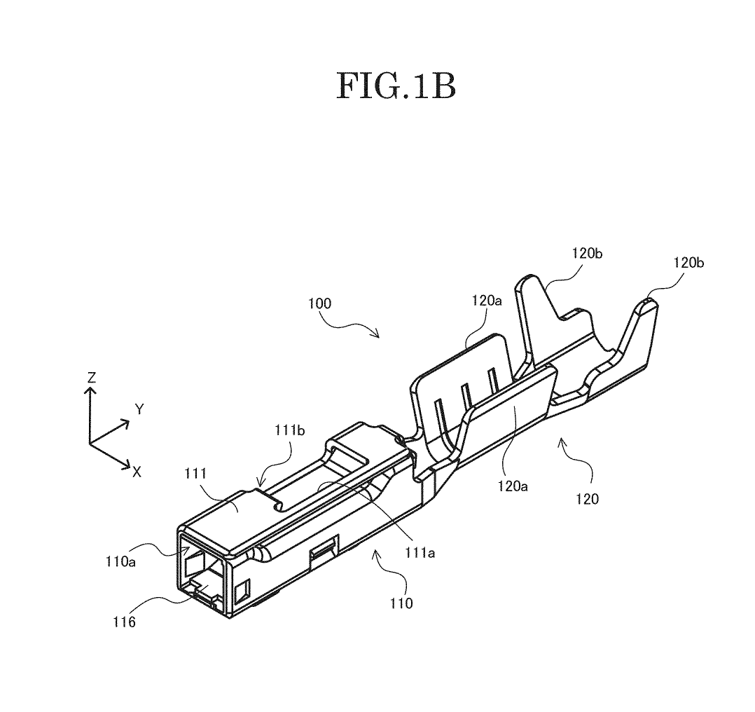

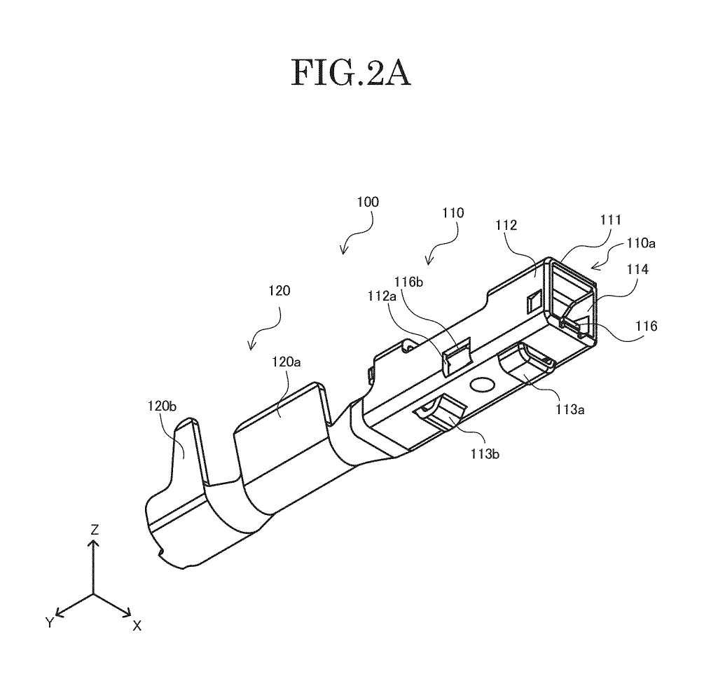

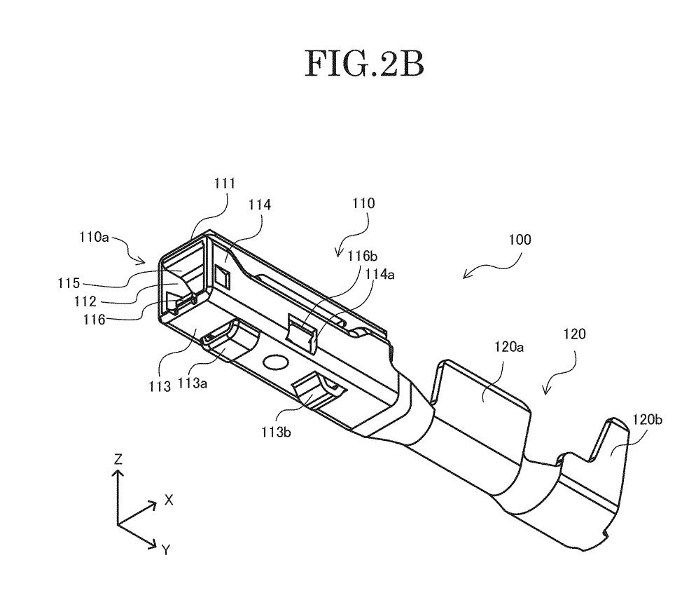

The female terminal 100 is a metal piece to be connected to an electric wire. With an electric wire connected, the female terminal 100 is fitted into a connector housing, which is described later. The connector housing containing the fitted female terminal 100 constitutes a connector on the female side. The female terminal 100 is formed by bending a metal plate. As illustrated in FIGS. 1 and 2, the female terminal 100 includes a body 110, which is a rectangular hollow tube into which a male terminal (not illustrated) is to be inserted, and a wire swaging portion 120, which is formed to be contiguous with the body 110.

A male terminal, namely the mating terminal of the female terminal 100, is to be inserted into the body 110. On one end of the body 110 with respect to its longitudinal direction, a terminal entry 110a is disposed to accept the inserted male terminal. The body 110 includes a top plate 111 (a first face), an outer wall plate 112, an outer bottom plate 113 (a second face), an outer wall plate 114, an inner wall plate 115, and a plate spring 116.

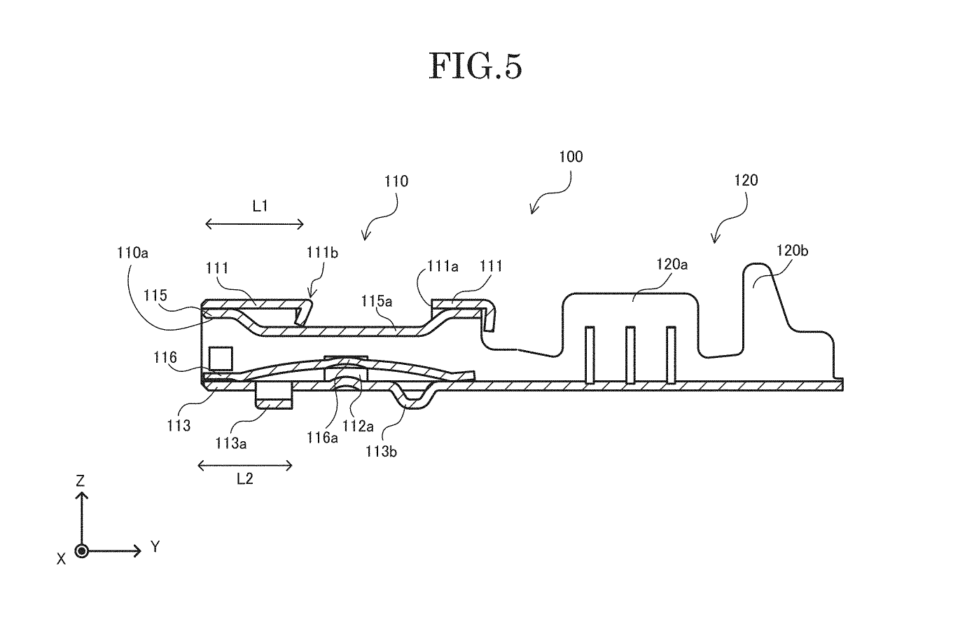

As illustrated in FIG. 2, the top plate 111 extends horizontally from a top end of the one outer wall plate 112. In the middle of the top plate 111, an opening 111a is formed as shown in FIG. 1. As illustrated in FIGS. 1 and 5, a lock portion 111b (a first lock portion) is formed on an edge of the opening 111a.

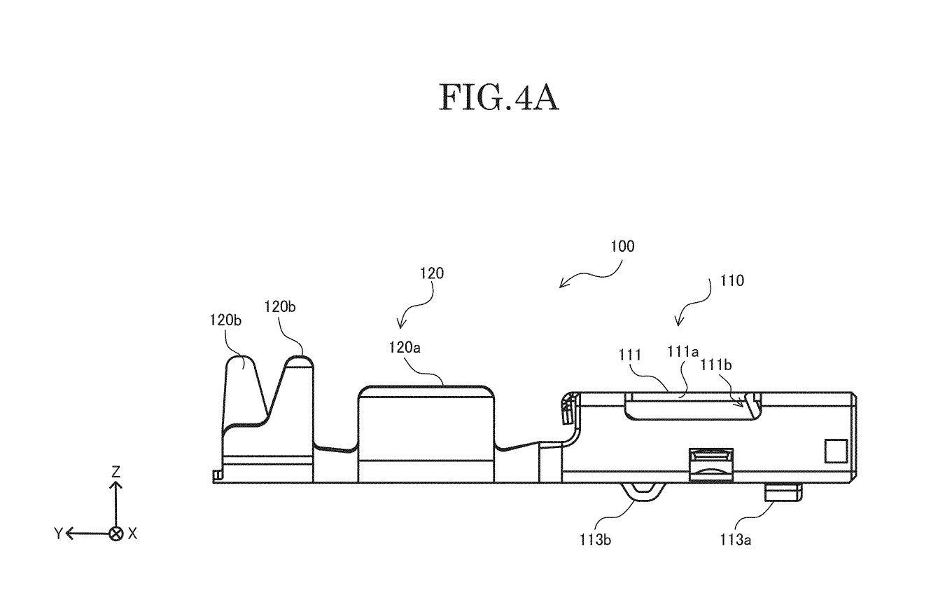

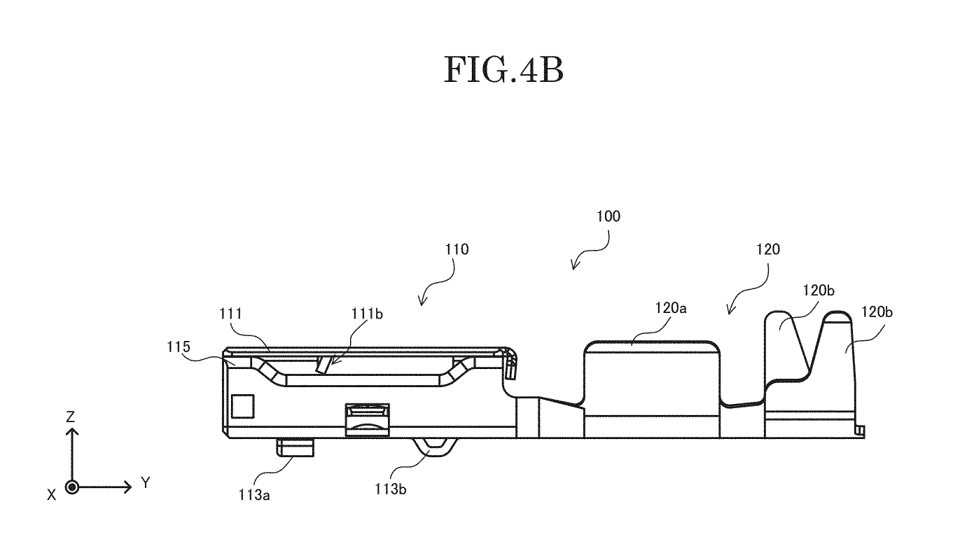

The lock portion 111b is to be locked by a lance in the connector housing, which is described later. As seen in FIGS. 1 and 4, the lock portion 111b is formed by, for example, bending part of an edge (a cut portion made in an edge) of the opening 111a inward from the body 110.

As illustrated in FIG. 2, the outer wall plate 112 extends vertically upward (in the +Z direction) from both ends of the outer bottom plate 113 with respect to its transverse direction (X-axis direction).

On the outer bottom plate 113, a lock portion 113a (a second lock portion) and an abutment 113b are disposed.

The lock portion 113a includes a projection formed to project outward (in the −Z direction) from the body 110. The lock portion 113a is to be locked by a lance formed in the connector housing, which is described later. As seen in FIG. 2, the lock portion 113a is formed by making two cuts substantially parallel to a side along the transverse direction (X-axis direction) of the outer bottom plate 113 and then striking out the area between the cuts from inside. As shown in FIG. 5, the lock portion 113a is formed so that the length L1 to the end of the body 110 along its longitudinal direction (Y-axis direction) is approximately equal to the length L2 from the lock portion 111b to the end of the body 110 along its longitudinal direction.

As illustrated in FIG. 2, the abutment 113b includes a projection protruding outward from the body 110. The abutment 113b is disposed for the purpose of preventing the female terminal 100 from rattling in the connector housing. The abutment 113b is formed by making two cuts substantially parallel to a side along the longitudinal direction (Y-axis direction) of the outer bottom plate 113 and then striking out the area between the cuts from inside.

The outer wall plate 114, along with the outer wall plate 112, extends vertically upward (in the +Z direction) from both ends of the outer bottom plate 113 with respect to its transverse direction (X-axis direction). The outer wall plate 114 faces the outer wall plate 112.

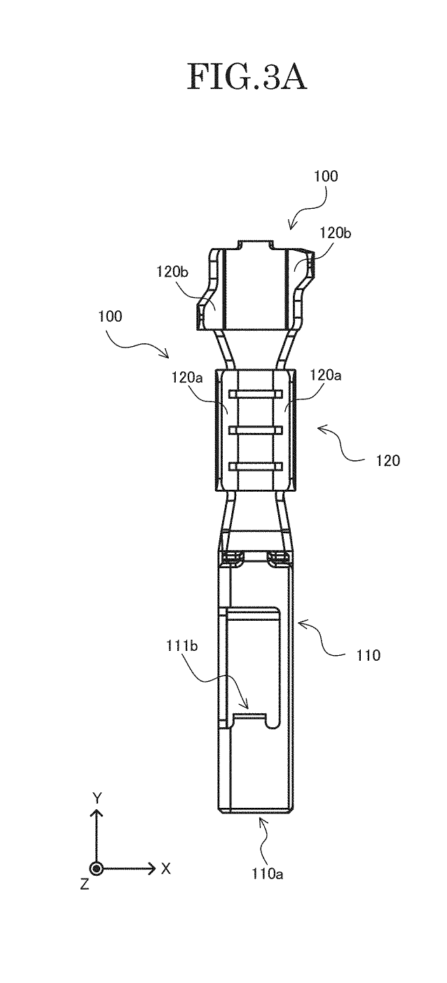

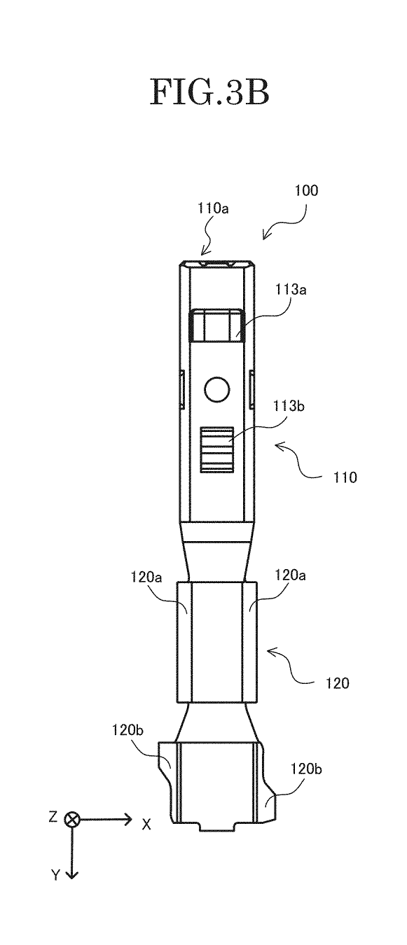

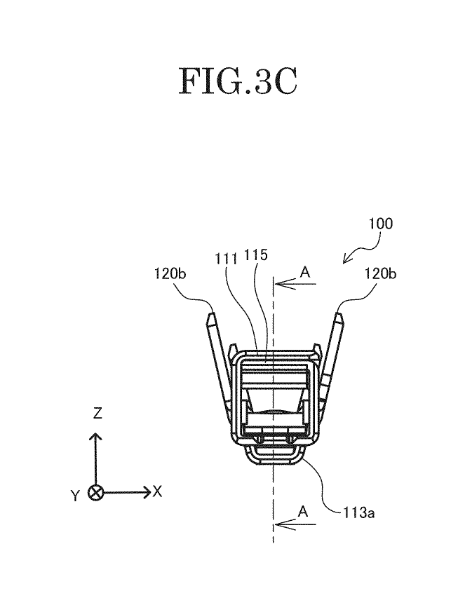

The inner wall plate 115 extends horizontally from the top end of the other outer wall plate 114. As illustrated in FIG. 3C, the inner wall plate 115 lies on the inner surface of the top plate 111. As illustrated in FIG. 5, a projection 115a protruding inward from the body 110 is formed in the middle of the inner wall plate 115. The projection 115a serves as a contact. The projection 115a is formed by striking out the material.

The plate spring 116 is a member formed of a resilient and electrically conductive plate material made from copper, a copper alloy, or the like. The plate spring 116 is placed so as to lie on the inner surface of the outer bottom plate 113. The plate spring 116 is formed so that the length along its longitudinal direction (Y-axis direction) is substantially equal to the length of the body 110 along its longitudinal direction. A projection 116a protruding inward from the body 110 is formed around the center of the plate spring 116 with respect to its longitudinal direction. Around the projection 116a of the plate spring 116, a pair of vanes 116b are formed to project in the transverse direction (X-axis direction) of the plate spring 116. As illustrated in FIGS. 2A and 2B, the vanes 116b are received in holes 112a and 114a in the outer wall plates 112 and 114, thereby restricting movement of the plate spring 116 in the longitudinal direction.

Refer to FIG. 5. The projection 116a serves as a contact. When the projection 116a and the projection 115a together press the male terminal (not illustrated) inserted into the body 110, the female terminal 100 and the male terminal are electrically connected.

The wire swaging portion 120 swages a wire so that the wire is connected to the female terminal 100. The wire swaging portion 120 includes two pairs of tabs 120a and 120b for fastening the wire.

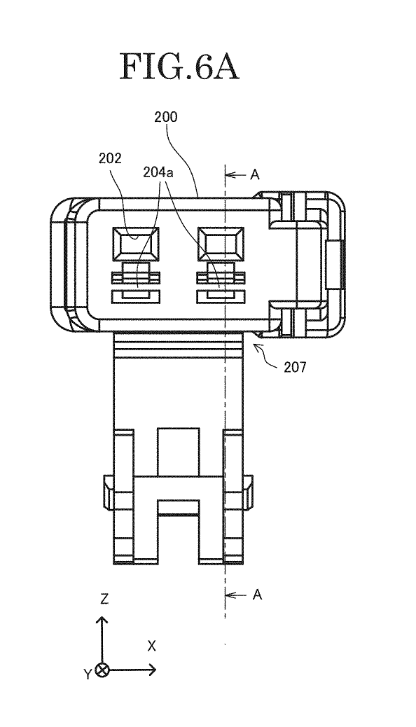

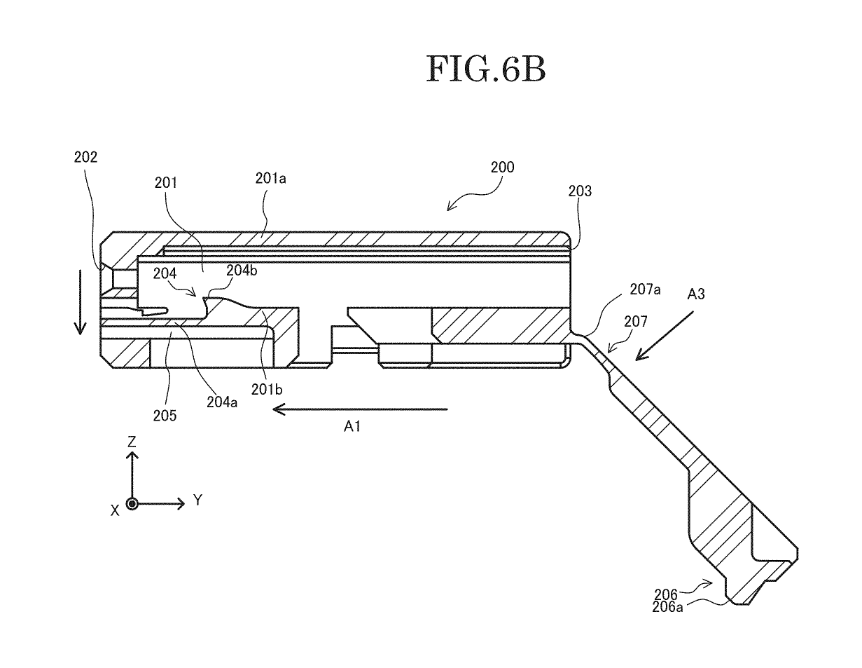

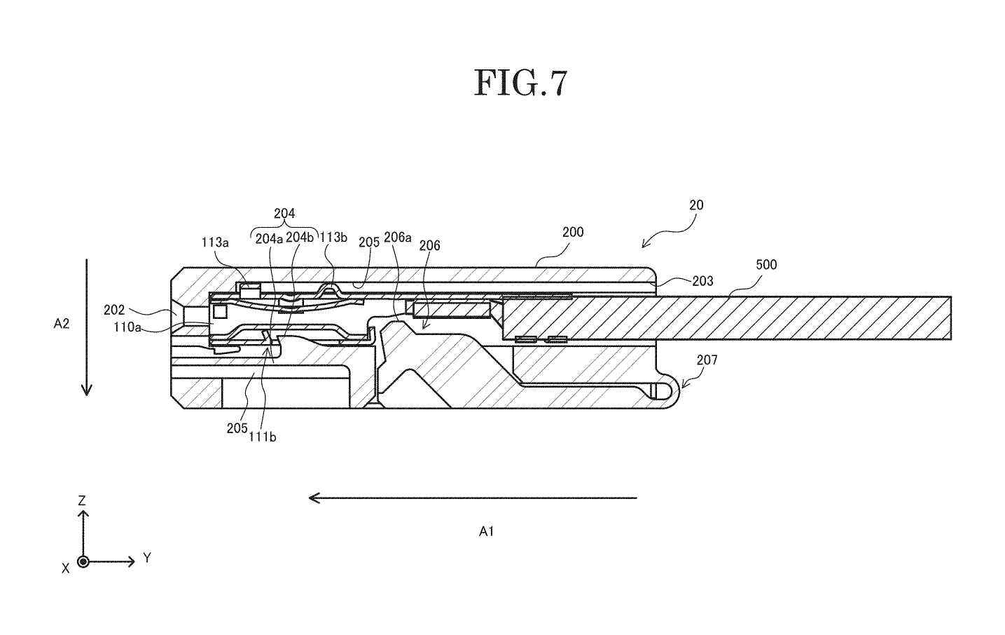

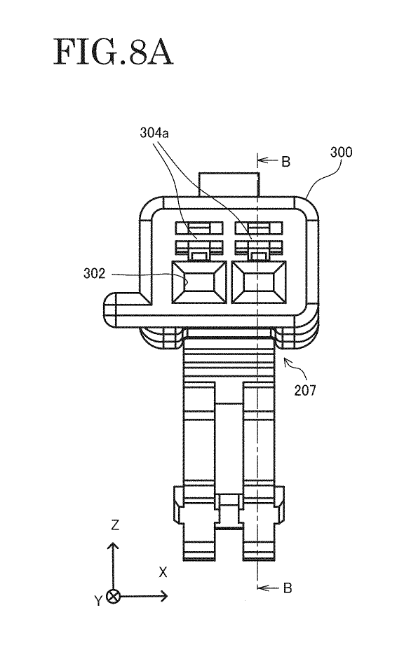

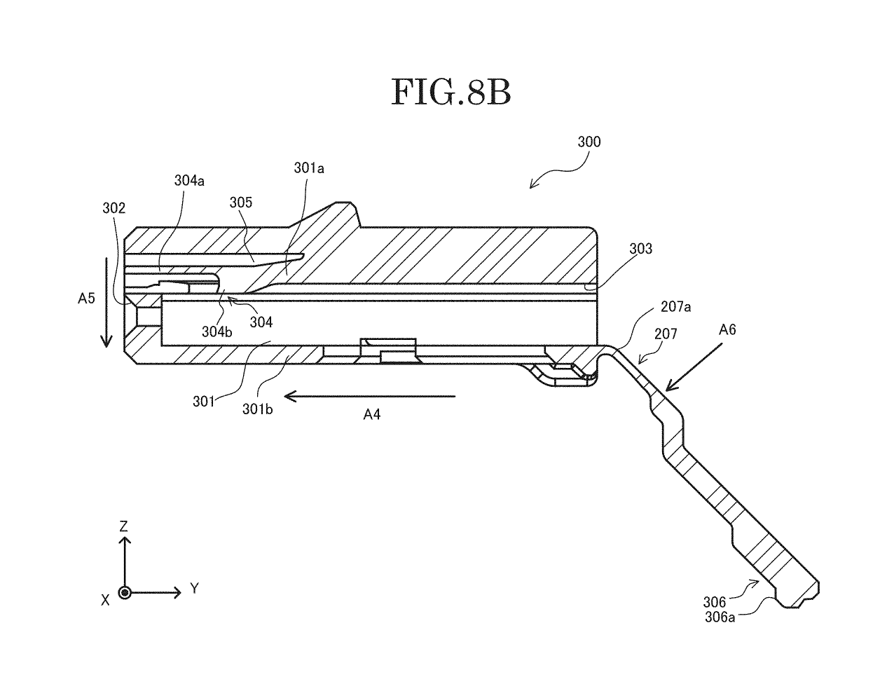

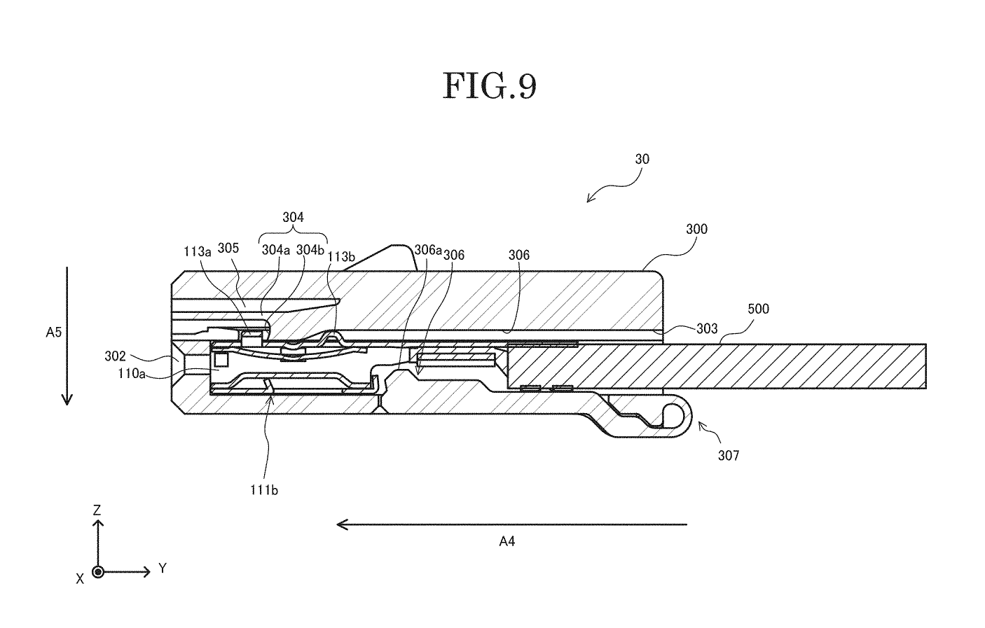

In the present embodiment, the female terminal 100 as configured above is fitted into either a connector housing 200 (a first connector housing) illustrated in FIGS. 6 and 7 or a connector housing 300 (a second connector housing) illustrated in FIGS. 8 and 9.

As illustrated in FIGS. 6 and 7, the connector housing 200 includes a terminal housing space 201, a terminal entry 202, a terminal entry 203, a lance 204, a lance retracting space 205, a secondary lock portion 206, and a hinge 207.

The connector housing 200, which is made of an electrically insulating synthetic resin into a rectangular-tubular shape, can contain two female terminals 100 fitted therein. The terminal housing space 201 (a first terminal housing space), which is a space for housing the female terminal 100, extends in the longitudinal direction (Y-axis direction) of the connector housing 200. Two terminal housing spaces 201 are disposed in the connector housing 200.

As illustrated in FIG. 6B, the terminal housing space 201 includes a ceiling wall 201a, a bottom wall 201b, and a pair of side walls facing each other (not illustrated). The pair of side walls extend vertically upward (in the +Z direction) from both ends of the bottom wall 201b. The ceiling wall 201a extends horizontally from the top end of the pair of side walls to face the bottom wall 201b.

The terminal entry 202 for a male terminal is disposed on one end of the connector housing 200 with respect to its longitudinal direction to accept a male terminal being inserted. As illustrated in FIG. 6A, the terminal entries 202 are arranged on the connector housing 200 in two columns along the width direction (X-axis direction) by one row along the height direction (Z-axis direction).

Refer to FIG. 6B. The terminal entry 203 is disposed on the other end of the connector housing 200 with respect to its longitudinal direction (Y-axis direction) to accept the female terminal 100 being inserted.

The lance 204 (a first lance) is responsible for primary locking of the female terminal 100 that has been housed in the terminal housing space 201. The lance 204 is disposed so as to separate the lance retracting space 205 from the terminal housing space 201. The terminal housing space 201 is defined on the +Z side of the lance 204.

The lance 204 includes a resilient portion 204a and a locking protrusion 204b. The resilient portion 204a is formed into a flat plate. One end of the resilient portion 204a with respect to its longitudinal direction (Y-axis direction) is formed to be integral with the bottom wall 201b, which forms part of the terminal housing space 201. As seen in FIG. 6A, the other end of the resilient portion 204a with respect to its longitudinal direction is formed to be integral with the face on which the terminal entries 202 of the connector housing 200 are disposed. As illustrated in FIG. 6B, the resilient portion 204a can resiliently deform in a direction (indicated by the arrow A2) orthogonal to the direction (indicated by the arrow A1) in which the female terminal 100 is inserted.

The locking protrusion 204b is formed to protrude from the resilient portion 204a toward the ceiling wall 201a of the terminal housing space 201. The locking protrusion 204b has a face to be in contact with the female terminal 100, the face being formed to be a slope rising away from the terminal entry 203 for the female terminal 100 toward the terminal entry 202 for the male terminal.

When being inserted into the connector housing 200, the female terminal 100 presses the locking protrusion 204b in the direction indicated by the arrow A2. The pressing by the female terminal 100 causes the resilient portion 204a to resiliently deform. As a result, the lance 204 retracts into the lance retracting space 205.

The lance retracting space 205 is a space into which the resiliently deforming lance 204 retracts. The lance retracting space 205 is disposed outside the terminal housing space 201.

The secondary lock portion 206 is responsible for secondary locking of the female terminal 100 in the connector housing 200. The secondary lock portion 206 includes a locking protrusion 206a intended to lock the female terminal 100. The secondary lock portion 206 is formed to be integral with the connector housing 200 via the hinge 207, being allowed to tilt by rotation of the hinge 207 as described later.

As illustrated in FIG. 7, when the hinge 207 rotates, the secondary lock portion 206 is caused to tilt and move upward from the lower side of the connector housing 200 (from the −Z to +Z side) to be attached to the connector housing 200. Upon attachment, a locking claw (not illustrated) disposed on the secondary lock portion 206 engages a lock portion (not illustrated) formed on the connector housing 200. In this way, the secondary lock portion 206 is locked in the connector housing 200.

When locked in the connector housing 200, the locking protrusion 206a of the secondary lock portion 206 is positioned closer to the terminal entry 203 for the female terminal 100 than the locking protrusion 204b of the lance 204, with respect to the longitudinal direction (Y-axis direction) of the connector housing 200.

To remove the secondary lock portion 206 from the connector housing 200, an unlocking claw (not illustrated) disposed on the secondary lock portion 206 is pressed to disengage the secondary lock portion 206 from a locking claw (not illustrated).

Refer to FIG. 6B. The hinge 207 connects the secondary lock portion 206 to the connector housing 200. The hinge 207 is connected to the connector housing 200 at one end (a supporting point 207a) of the hinge 207, while connected to the secondary lock portion 206 at the other end.

The hinge 207 can rotate on the X axis around the supporting point 207a. When a force is applied to the hinge 207 in a direction indicated by the arrow A3, the hinge 207 rotates clockwise around the supporting point 207a. Hence, the secondary lock portion 206 is attached to the connector housing 200 upward from the lower side of the connector housing 200 (from the −Z to +Z side). When the secondary lock portion 206 is removed from the connector housing 200, the hinge 207 rotates counterclockwise around the supporting point 207a.

The following describes how the lance 204 moves when the female terminal 100 is inserted into the connector housing 200. Refer to FIG. 6B. When the connector housing 200 is to be inserted, the female terminal 100 is inserted into the connector housing 200 with the outer bottom plate 113 of the female terminal 100 situated on the upper side (+Z side) of the top plate 111.

After entering the connector housing 200, the female terminal 100 advances in the connector housing 200 in a direction indicated by the arrow Al and passes over the locking protrusion 204b of the lance 204. At the same time, the top plate 111 of the body 110 of the female terminal 100 abuts on and presses the locking protrusion 204b of the lance 204. Thus, the resilient portion 204a resiliently deforms to cause the lance 204 to retract into the lance retracting space 205.

When the female terminal 100 has been fitted into the terminal housing space 201 in place as shown in FIG. 7, the locking protrusion 204b of the lance 204 returns to the original position owing to the resiliency to lock the lock portion 111b of the female terminal 100. Hence, the female terminal 100 is prevented from being released. Meanwhile, the lock portion 113a of the female terminal 100 is not locked on anywhere in the connector housing 200.

Then, the hinge 207 is rotated to cause the secondary lock portion 206 to be attached to the connector housing 200 from the lower side of the connector housing 200 (from the −Z to +Z side).

In the event that the body 110 of the female terminal 100 moves in the direction of exiting from the connector housing 200 (the direction opposite to the arrow Al), the body 110 abuts on the locking protrusion 206a of the secondary lock portion 206, with the result that the female terminal 100 is prevented from being released.

Note that the secondary lock portion 206 cannot be attached to the connector housing 200 until the female terminal 100 is fitted into the terminal housing space 201 in place. In this way, it can be detected whether the female terminal 100 is being inserted (whether the female terminal 100 has not been fitted into the terminal housing space 201 in place yet) by using the secondary lock portion 206.

When the female terminal 100 is fitted in place, there is a space (gap) between the female terminal 100 and the ceiling wall 201a of the terminal housing space 201 in the connector housing 200. The space is provided in order that the lock portion 113a, which protrudes outward from the female terminal 100, does not prevent the female terminal 100 from entering the terminal housing space 201.

However, the gap between the female terminal 100 and the ceiling wall 201a may cause the female terminal 100 to move (rattle) within the terminal housing space 201. Thus, the abutment 113b is disposed on the female terminal 100. When the female terminal 100 is fitted into the connector housing 200, both the lock portion 113a and the abutment 113b of the female terminal 100 abut on the ceiling wall 201a of the terminal housing space 201. As a result, the female terminal 100 is prevented from rattling.

The following describes a method for producing a connector 20, which includes the above-described connector housing 200 and female terminal 100. For example, an operator prepares the connector housing 200 and two female terminals 100 in a factory. The operator inserts one of the female terminals 100 from the terminal entry 203 into the connector housing 200 until the female terminal 100 is fitted into the terminal housing space 201 in place. The operator makes sure that the lance 204 of the connector housing 200 has locked the lock portion 111b of the female terminal 100 by hearing a locking sound (a click sound), and then attaches the secondary lock portion 206 to the connector housing 200. The operator rotates the hinge 207 to attach the secondary lock portion 206 to the connector housing 200 from the lower side of the connector housing 200 (from the −Z to +Z side). Then, the operator proceeds with fitting the other female terminal 100 into the connector housing 200.

Referring to FIGS. 8 and 9, the following describes another connector housing 300 (a second connector housing) into which the female terminal 100 is fitted. In the following description, identical reference symbols are given to elements identical to those in the connector housing 200 and detailed descriptions thereof are omitted.

The connector housing 300, which includes two terminal housing spaces 301 (second terminal housing spaces), can contain two female terminals 100 fitted therein.

As illustrated in FIG. 8A, the terminal entries 302 for a male terminal are arranged on the connector housing 300 in two columns along the width direction (X-axis direction) by one row along the height direction (Z-axis direction). The vertical position of the terminal entry 302 (along the Z-axis direction) is lower than that of the terminal entry 202 in the connector housing 200 (FIG. 6A) (along the Z-axis direction). In other words, the vertical position of the terminal housing space 301 in the connector housing 300 (along the Z-axis direction) is different from that of the terminal housing space 201 in the connector housing 200.

As with the lance 204 in the connector housing 200, the lance 304 (a second lance) is responsible for primary locking of the female terminal 100 that has been housed in the terminal housing space 301. As illustrated in FIG. 8B, the lance 304 is disposed so as to separate the lance retracting space 305 from the terminal housing space 301. The terminal housing space 301 is defined on the −Z side of the lance 304.

The lance 304 includes a resilient portion 304a and a locking protrusion 304b. The resilient portion 304a is formed into a flat plate. One end of the resilient portion 304a with respect to its longitudinal direction (Y-axis direction) is formed to be integral with the ceiling wall 301a, which forms part of the terminal housing space 301. As seen in FIG. 8A, the other end of the resilient portion 304a with respect to its longitudinal direction is formed to be integral with the face on which the terminal entries 302 of the connector housing 300 are disposed.

Refer to FIG. 8B. The resilient portion 304a of the lance 304 can resiliently deform in a direction (indicated by the arrow A5) orthogonal to the direction (indicated by the arrow A4) in which the female terminal 100 is inserted. The locking protrusion 304b is formed to protrude from the resilient portion 304a toward the bottom wall 301b of the terminal housing space 301. The locking protrusion 304b has a face to be in contact with the female terminal 100, the face being formed to slope downwards away from the terminal entry 303 for the female terminal 100 toward the terminal entry 302 for the male terminal.

The secondary lock portion 306 is responsible for secondary locking of the female terminal 100 in the connector housing 300. The secondary lock portion 306 includes a locking protrusion 306a intended to lock the female terminal 100. The secondary lock portion 306 is configured in the same way as the secondary lock portion 206 of the connector housing 200.

As illustrated in FIG. 9, when the below-mentioned hinge 307 rotates, the secondary lock portion 306 is caused to tilt and move upward from the lower side of the connector housing 300 (from the −Z to +Z side) to be attached to the connector housing 300. Upon attachment, a locking claw (not illustrated) disposed on the secondary lock portion 306 engages a lock portion (not illustrated) formed on the connector housing 300. In this way, the secondary lock portion 306 is locked in the connector housing 300.

Refer to FIG. 8B. The hinge 307 is configured in the same way as the hinge 207 of the connector housing 200. When a force is applied to the hinge 307 in a direction indicated by the arrow A6, the hinge 307 rotates clockwise around the supporting point 307a. Hence, the secondary lock portion 306 is attached to the connector housing 300 upward from the lower side of the connector housing 300 (from the −Z to +Z side).

The following describes how the lance 304 moves when the female terminal 100 is inserted into the housing. Refer to FIG. 8B. When the connector housing 300 is to be inserted, the female terminal 100 is inserted into the connector housing 300 with the outer bottom plate 113 of the female terminal 100 situated on the upper side (+Z side) of the top plate 111.

After entering the connector housing 300, the female terminal 100 advances in the connector housing 300 in a direction indicated by the arrow A4 and passes over the locking protrusion 304b of the lance 304. At the same time, the top plate 113 of the body 110 of the female terminal 100 abuts on and presses the locking protrusion 304b of the lance 304. Thus, the resilient portion 304a resiliently deforms to cause the lance 304 to retract into the lance retracting space 305.

When the female terminal 100 has been fitted into the terminal housing space 301 in place as shown in FIG. 9, the locking protrusion 304b of the lance 304 returns to the original position owing to the resiliency to lock the lock portion 113 a of the female terminal 100. Hence, the female terminal 100 is prevented from being released. Meanwhile, the lock portion 111b of the female terminal 100 is not locked on anywhere in the connector housing 300. Then, the hinge 307 is rotated to cause the secondary lock portion 306 to be attached to the connector housing 300 from the lower side of the connector housing 300 (from the −Z to +Z side).

In the event that the body 110 of the female terminal 100 moves in the direction of exiting from the connector housing 300 (the direction opposite to the arrow A4), the body 110 abuts on the locking protrusion 306a of the secondary lock portion 306, with the result that the female terminal 100 is prevented from being released.

Note that the secondary lock portion 306 cannot be attached to the connector housing 300 until the female terminal 100 is fitted into the terminal housing space 301 in place. In this way, it can be detected whether the female terminal 100 is being inserted (whether the female terminal 100 has not been fitted into the terminal housing space 301 in place yet) by using the secondary lock portion 306.

A connector 30, which includes the above-described connector housing 300 and female terminal 100, is produced by a method similar to the method for the connector 20. For example, an operator prepares the connector housing 300 and two female terminals 100 and fits the individual female terminals 100 into the connector housing 300 in a factory. As with the connector 20, the operator can make sure that the lance 304 of the connector housing 300 has locked the lock portion 113a of the female terminal 100 by hearing a locking sound (a click sound). Then, the operator attaches the secondary lock portion 306 to the connector housing 300, and proceeds with fitting the other female terminal 100 into the connector housing 300.

As described above, the female terminal 100 according to the present embodiment includes the lock portions 111b and 113a. Hence, the female terminal 100 can be applied to the connector housings 200 and 300, which are adapted to the lock portion 111b and the lock portion 113a, respectively. As a result, the female terminal 100 can be used for both of the different types of connector housings 200 and 300.

The lock portion 111b is formed by bending a cut portion, while the lock portion 113a is formed by striking out the outer bottom plate 113. Therefore, the female terminal 100 can be easily produced in spite of two lock portions included.

In addition, the abutment 113b included in the female terminal 100 prevents the female terminal 100 from rattling within the housing; otherwise the rattling may be caused by the lock portion 113a. Furthermore, since the abutment 113b is formed by striking, the female terminal 100 can be easily produced.

The embodiments of the present disclosure have been described above, but the present disclosure is not limited to the foregoing embodiments.

The lock portion 113a of the female terminal 100 may be formed by striking out the outer bottom plate 113 from the inside of the body 110, without making a cut in the outer bottom plate 113.

The abutment 113b of the female terminal 100 may be formed by striking out the outer bottom plate 113 from the inside of the body 110, without making a cut in the outer bottom plate 113.

The female terminal 100 according to the embodiments can be used for both of the different types of connector housings 200 and 300. The female terminal 100 offers the advantages described below.

The industry has a desire to change the vertical position at which the male and female terminals are fitted together in a connector depending on the product involving the connector, without changing the size (the height, in particular) of the connector housing. The desire can be satisfied by changing the position of the terminal housing space upward or downward within the connector housing.

In this case, however, the position of the lance will also be changed depending on the position of the terminal housing space, because of the necessity to place both the terminal housing space and the lance in a limited space within the connector housing. Specifically, assuming that the terminal housing space is placed in an upper region of the connector housing, the lance will be placed on the lower side of the terminal housing space so that the locking protrusion protrudes from the inner bottom wall of the terminal housing space. On the other hand, assuming that the terminal housing space is placed in a lower region of the connector housing, the lance will be placed on the upper side of the terminal housing space so that the locking protrusion protrudes from the inner top wall of the terminal housing space.

If only one lock portion is disposed on the female terminal as in Patent Literature 1 described above, the design of the female terminal has to be changed so as to have a lock portion positioned appropriately for the position of the lance in the connector housing.

In contrast, the female terminal 100 according to the embodiments of the present disclosure can be used for both of the different connector housings 200 and 300, eliminating the need for designing different female terminals for the individual connector housings. As a result, production cost can be reduced.

In the example described in the foregoing embodiment, the connector housings 200 and 300 are separate from each other. However, the connector housings 200 and 300 may be integrated with each other. For example, a connector housing may be formed by joining together the outer side (the −X side) of the connector housing 200 illustrated in FIG. 6A and the outer side (the +X side) of the connector housing 300 illustrated in FIG. 8A. This connector housing has four terminal entries on a single face. This connector housing also allows a female terminal to be used in any of the housings, and thus four female terminals of the same type need only be prepared.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A female terminal to be inserted into a tubular terminal housing space formed within either of two types of insulative connector housings, the female terminal comprising:
a hollow tubular body into which a male terminal that is a mating terminal, is to be inserted;
a first lock portion that is disposed on a first face of the body and that is to be locked by a lance formed in a connector housing of one type; and
a second lock portion that is disposed on a second face facing the first face of the body and that is to be locked by a lance formed in a connector housing of another type.

2. The female terminal according to claim 1,
wherein the first lock portion comprises a projection in such a form that a cut portion made in the first face of the body is bent inward from the body.

3. The female terminal according to claim 1,
wherein the second lock portion comprises a projection in such a form that part of the second face of the body protrudes outward from the body.

4. A connector comprising a first connector housing, a second connector housing, and a plurality of female terminals allowed to be fitted into any of the first connector housing and the second connector housing,
wherein the first connector housing comprises: a first terminal housing space that is capable of housing each of the female terminals; and a first lance that locks each of the female terminals,
wherein the second connector housing comprises: a second terminal housing space that is capable of housing each of the female terminals; and a second lance that locks each of the female terminals and that is in a shape different from the first lance,
wherein the female terminals each comprise:
a hollow tubular body into which a male terminal is to be inserted;
a first lock portion disposed on a first face of the body; and
a second lock portion disposed on a second face facing the first face of the body,
wherein at least one of the female terminals is fitted into the first terminal housing space in the first connector housing with the first lock portion locked by the first lance, and
wherein other remaining female terminals are each fitted into the second terminal housing space in the second connector housing with the second lock portion locked by the second lance.

5. The connector according to claim 4,
wherein the first terminal housing space in the first connector housing includes a space in such a size and shape that the second lock portion of the female terminal does not prevent the female terminal from entering the first terminal housing space, and
wherein the second terminal housing space in the second connector housing includes a space in such a size and shape that the first lock portion of the female terminal does not prevent the female terminal from entering the second terminal housing space.

6. The connector according to claim 4,
wherein the female terminal comprises an abutment on the second face, the abutment being to abut on an inner surface of the second terminal housing space.

7. A method for producing a connector, the method comprising the steps of:
preparing
a first connector housing that is capable of housing each of a plurality of female terminals and that comprises a first terminal housing space in which a first lance is formed,
a second connector housing that is capable of housing each of the plurality of female terminals and that comprises a second terminal housing space in which a second lance is formed, and
the plurality of female terminals each of which has an identical structure and comprises: a hollow tubular body into which a male terminal is to be inserted; a first lock portion that is disposed on a first face of the body and that is to be locked by the first lance; and a second lock portion that is disposed on a second face facing the first face of the body and that is to be locked by the second lance;
fitting at least one of the female terminals into the first terminal housing space in the first connector housing so that the first lock portion is locked by the first lance; and
fitting each of other remaining female terminals into the second terminal housing space in the second connector housing so that the second lock portion is locked by the second lance.
